(19) United States
(12) Patent Application Publication
(10) Pub. No.: US 2015/0144507 A1
(43) Pub. Date: May 28, 2015

(54) FOLDED BIOSENSOR

(71) Applicant: Cilag GmbH International, Zug (CH)

(72) Inventor: Russell BAIN, Inverness (GB)

(73) Assignee: Cilag GmbH International, Zug (CH)

(21) Appl. No.: 14/087,524

(22) Filed: Nov. 22, 2013

(51) Int. Cl. G01N 27/327

(52) U.S. Cl. CPC G01N 27/3272
USPC 205/792; 204/403.02

(57) ABSTRACT

A test strip comprising two electrodes having conducting surfaces facing inwardly toward each other in a distal portion of the test strip adjacent a sample chamber. A pair of spacers are disposed, each adjacent one side of the sample chamber, between the electrodes. The electrodes each face in one direction at a proximal end of the test strip so that their conducting surfaces form electrical contacts of the test strip.

### TECHNICAL FIELD

The present disclosure generally relates to the field of sample analytical measurement systems and more specifically to an improved analytical test strip design including methods of fabrication and use thereof in a sample measurement system.

### BACKGROUND

Blood analyte measurement systems typically comprise an analyte test meter that is configured to receive a biosensor, usually in the form of an analytical test strip. A user may obtain a small sample of blood typically by a fingertip skin prick and then apply the sample to the test strip in order to begin a blood analyte assay. Because many of these measurement systems are portable, and testing can be completed in a short amount of time, patients are able to use such devices in the normal course of their daily lives without significant interruption to their personal routines. As a result, a person with diabetes may measure his or her blood glucose level several times a day as a part of a self management process to ensure glycemic control of blood glucose within a target range.

Analyte detection assays find use in a variety of applications, including clinical laboratory testing, home testing, etc., where the results of such testing play a prominent role in diagnosis and management of a variety of disease conditions. Analytes of interest include glucose for diabetes management, cholesterol, and the like. In response to this growing importance of analyte detection, a variety of analyte detection protocols and devices for both clinical and home use have been developed.

One type of method that is employed for analyte detection is an electrochemical method. In such methods, a blood sample is placed into a sample-receiving chamber in an electrochemical cell that includes two electrodes, e.g., a counter electrode and a working electrode, and a redox reagent. The blood analyte is allowed to react with the redox reagent to form an oxidizable (or reducible) substance in an amount corresponding to the blood analyte concentration. The quantity or concentration of the oxidizable (or reducible) substance present is then estimated electrochemically by applying a voltage signal via the electrodes and measuring an electrical response which is related to the amount of analyte present in the initial sample.

The electrochemical cell is typically present in a test strip which is configured to electrically connect the electrochemical cell to an analyte measurement device such as a test meter. While current test strips are effective, the method of fabricating these test strips can directly impact the manufacturing costs. For example, current manufacturing processes may require three separately registered steps to form a single strip: a castellated connector cut, a punched chamber formation, and a registered singulation process. All three of these steps may incur waste through mis-registration. Accordingly, there is a need for an improved electrochemical test strip and for fabrication methods and structures to reduce material and manufacturing costs.

Embodiments disclosed herein generally provide an analytical test strip having co-facial electrodes that engage electrical connectors of a test meter, a web-based method of manufacturing the test strip that reduces costs, and a method of using the test strip design in a sample analytical system, while providing electrical contact areas for easy access by a hand held analyte measurement device such as a blood glucose test meter.

An advantage provided herein by the described analytical test strip is that the electrical contact areas present completely accessible full strip width layer electrodes to the meter. This presentation allows for greater tolerances in the manufacture of the strip port connector of the test meter and a simpler test meter design, because only two electrical connections are required.

Another advantage provided herein by the described analytical test strip is that of overall greater functionality for use in a sample analyte measurement system. Greater functionality is afforded due to the folded electrode layer that allows free contact to both electrodes for a conventionally inserted side-fill analytical test strip, without the need to make an electrical transfer joint.

Another advantage realized is that of cost savings by reducing material and manufacturing costs through a continuous web-based construction that requires no downstream registration features. The web may be cut by a continuous guillotine process that improves yield whilst reducing material waste and cost.

Still another advantage provided is that of a simplified construction of the test strips. This means the analytical test strips have both greater functionality and reduced inventory resulting in significant performance and cost savings. A novel lamination-and-folding fabrication process is described herein.

These and other embodiments, features and advantages will become apparent too those skilled in the art when taken with reference to the following more Detailed Description of various exemplary embodiments of the invention in conjunction with the accompanying drawings that are first briefly described.

### BRIEF DESCRIPTION OF THE DRAWINGS

The accompanying drawings, which are incorporated herein and constitute part of this specification, illustrate presently preferred embodiments of the invention, and, together with the general description given above and the detailed description given below, serve to explain features of the invention (wherein like numerals represent like elements).

FIG. 1A illustrates a diagram of an exemplary analytical test strip based blood analyte measurement system;

FIG. 1B illustrates a diagram of an exemplary processing system of the test strip based blood analyte measurement system of FIG. 1A;

FIG. 2A is a side view of an analytical test strip formed by an exemplary fabrication method disclosed herein;

FIG. 2B is an exploded perspective view of the exemplary analytical test strip of FIG. 2A;

FIG. 3A is a top view of a portion of the web-based process for manufacturing the exemplary analytical test strip of FIGS. 2A-B; and

FIG. 3B is a side view of the exemplary analytical test strip web of FIG. 3A.

### EXEMPLARY MODES OF CARRYING OUT THE INVENTION

Certain exemplary test strip embodiments will now be described to provide an overall understanding of the principles of the structure, function, manufacture, and use of the test strips and methods of fabrication disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present disclosure is defined solely by the claims. The features illustrated or described in connection with one exemplary embodiment may be combined with the features of other embodiments. Such modifications and variations are intended to be included within the scope of the present disclosure.

As used herein, the terms “patient” or “user” refer to any human or animal subject and are not intended to limit the systems or methods to human use, although use of the subject invention in a human patient represents a preferred embodiment.

The term “sample” means a volume of a liquid, solution or suspension, intended to be subjected to qualitative or quantitative determination of any of its properties, such as the presence or absence of a component, the concentration of a component, e.g., an analyte, etc. The embodiments of the present invention are applicable to human and animal samples of whole blood. Typical samples in the context of the present invention as described herein include blood, plasma, red blood cells, serum and suspensions thereof.

The term “about” as used in connection with a numerical value throughout the description and claims denotes an interval of accuracy, familiar and acceptable to a person skilled in the art. The interval governing this term is preferably ±10%. Unless specified, the terms described above are not intended to narrow the scope of the invention as described herein and according to the claims. The terms “top” and “base” as used herein are intended to serve as a reference for illustration purposes only, and that the actual position of the portions of the test strip will depend on its orientation.

The embodiments generally relate to a web-based construction of an electrochemical biosensor (herein also synonymously referred to as a “test strip”, having electrodes that communicate with an analyte measurement system or device. The biosensor is particularly advantageous as it offers a relatively small size, while requiring a relatively simple, efficient manufacturing process. The efficient manufacturing process may reduce manufacturing costs, as less material is wasted.

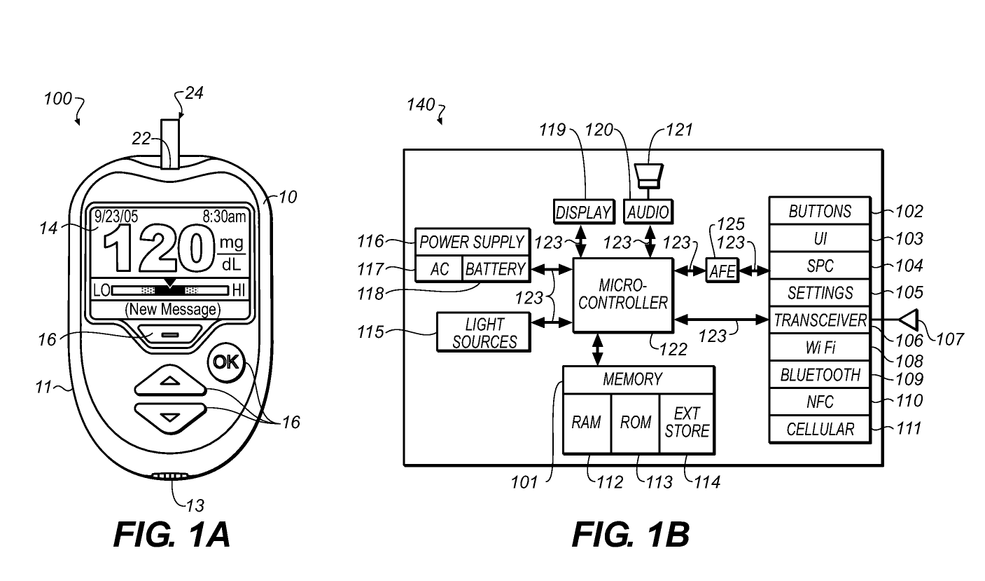

FIG. 1A illustrates an analyte measurement system 100 that includes a portable test meter 10. The test meter 10 is defined by a housing 11 that retains a data management unit 140 and further includes a strip port connector 22 sized and configured for receiving an analytical test strip. According to one embodiment, the test meter 10 may be a blood glucose meter and the test strip is provided in the form of a glucose test strip 24 configured for insertion into a defined test strip port connector 22 for performing blood glucose measurements. As noted, the test meter 10 retains a data management unit 140, FIG. 1B, which is disposed within the interior of the meter housing 11. A plurality of user interface buttons 16 and a display 14 are disposed on the exterior of the housing 11 wherein the meter further comprises, the strip port connector 22, and a data port 13, as illustrated in FIG. 1A. A predetermined number of glucose test strips 24 may be stored within the housing 11 and made accessible for individual use in blood glucose testing. The plurality of user interface buttons 16 can be configured to allow the entry of data, to prompt an output of data, to navigate menus that are presented on the display 14, and to execute commands. Output data can include values representative of analyte concentration presented on the display 14. Input information, which is related to the everyday lifestyle of an individual, can include food intake, medication use, occurrence of health check-ups, and general health condition and exercise levels of an individual. These inputs can be requested via prompts presented on the display 14 and can be stored in a memory module of the analyte meter 10. Specifically and according to this exemplary embodiment, the user interface buttons 16 include markings, e.g., up-down arrows, text characters (e.g., “OK”), which allow a user to navigate through the user interface presented on the display 14. Although the user interface buttons 16 shown herein are separate switches, a touch screen interface on the display 14 with virtual buttons may also be alternatively utilized.

The electronic components of the glucose measurement system 100 can be disposed on, for example, a printed circuit board situated within the meter housing 11 and forming the data management unit 140 of the herein described system. FIG. 1B illustrates, in simplified schematic form, several of the electronic sub-systems disposed within the housing 11 for purposes of this embodiment. The data management unit 140 according to this exemplary embodiment includes a processing unit 122 in the form of a microprocessor, a microcontroller, an application specific integrated circuit (“ASIC”), a mixed signal processor (“MSP”), a field programmable gate array (“FPGA”), or a combination thereof, and is electrically connected to various electronic modules included on, or connected to, the printed circuit board, as will be described below. The processing unit 122 is electrically connected to, for example, a test strip port circuit module 104 via an analog front end sub-system 125. The strip port circuit 104 is electrically connected to the strip port connector 22 during blood glucose testing.

In brief and to measure a selected analyte concentration, the strip port circuit 104 detects a resistance across electrodes of the analyte test strip 24 having a blood sample disposed thereon, using a potentiostat, and converts an electric current measurement into digital form for presentation on the display 14. The processing unit 122 can be configured to receive input from the strip port circuit 104 and may also perform a portion of the potentiostat function and the current measurement function.

The analyte test strip 24 can be in the form of an electrochemical glucose test strip. The test strip 24 can include one or more working electrodes. Test strip 24 can also include a plurality of electrical contact pads, in which each electrode can be in electrical communication with at least one electrical contact pad. The strip port connector 22 can be configured to electrically interface to the electrical contact pads and form electrical communication with the electrodes of an inserted test strip. Test strip 24 can include a reagent layer that is disposed over at least one electrode. The reagent layer can include an enzyme and a mediator. Exemplary enzymes suitable for use in the reagent layer include glucose oxidase, glucose dehydrogenase (with pyrroloquinoline quinone co-factor, “PQQ”), and glucose dehydrogenase (with flavin adenine dinucleotide co-factor, “FAD”). An exemplary mediator suitable for use in the reagent layer includes ferricyanide, which in this case is in the oxidized form. The reagent layer can be configured to physically transform glucose into an enzymatic by-product and in the process generate an amount of reduced mediator (e.g., ferrocyanide) that is proportional to the glucose concentration. The working electrode can then be used to measure a concentration of the reduced mediator in the form of a current. In turn, the strip port circuit 104 can convert the current magnitude into a glucose concentration. An exemplary analyte meter for performing such current measurements is described in U.S. Patent Application Publication No. US 1259/0301899 A1 entitled “System and Method for Measuring an Analyte in a Sample”, which is incorporated by reference herein in its entirety.

A display module 119, which may include a display processor and display buffer, is electrically connected to the processing unit 122 over the communication interface 123 for receiving and displaying output data, and for displaying user interface input options under control of processing unit 122. The structure of the user interface, such as menu options, is stored in user interface module 103 and is accessible by the processing unit 122 for presenting menu options to a user of the blood glucose measurement system 100. According to this exemplary embodiment, an audio module 120 includes a speaker 121 for outputting audio data received or stored by the DMU 140. Audio outputs can include, for example, notifications, reminders, and alarms, or may include audio data to be replayed in conjunction with display data presented on the display 14. Such stored audio data can be accessed by processing unit 122 and executed as playback data at appropriate times. A volume of the audio output is controlled by the processing unit 122, and the volume setting can be stored in settings module 105, as determined by the processor or as adjusted by the user. User input module 102 receives inputs via user interface buttons 16 which are processed and transmitted to the processing unit 122 over the communication interface 123. The processing unit 122 may have electrical access to a digital time-of-day clock connected to the printed circuit board for recording dates and times of blood glucose measurements, which may then be accessed, uploaded, or displayed at a later time as necessary.

The display 14 can alternatively include a backlight whose brightness may be controlled by the processing unit 122 via a light source control module 115. Similarly, the user interface buttons 16 may also be illuminated using LED light sources electrically connected to processing unit 122 for controlling a light output of the buttons. The light source module 115 is electrically connected to the display backlight and processing unit 122. Default brightness settings of all light sources, as well as settings adjusted by the user, are stored in a settings module 105, which is accessible and adjustable by the processing unit 122.

A memory module 101, that includes but are not limited to volatile random access memory (“RAM”) 112, a non-volatile memory 113, which may comprise read only memory (“ROM”) or flash memory, and a circuit 114 for connecting to an external portable memory device via a data port 13, is electrically connected to the processing unit 122 over a communication interface 123. External memory devices may include flash memory devices housed in thumb drives, portable hard disk drives, data cards, or any other form of electronic storage devices. The on-board memory can include various embedded applications executed by the processing unit 122 for operation of the test meter 10, as will be explained below. On board memory can also be used to store a history of a user's blood glucose measurements including dates and times associated therewith. Using the wireless transmission capability of the test meter 10 or the data port 13, as described below, such measurement data can be transferred via wired or wireless transmission to connected computers or other processing devices.

A wireless module 106 may include transceiver circuits for wireless digital data transmission and reception via one or more internal digital antennas 107, and is electrically connected to the processing unit 122 over communication interface 123. The wireless transceiver circuits may be in the form of integrated circuit chips, chipsets, programmable functions operable via processing unit 122, or a combination thereof. Each of the wireless transceiver circuits is compatible with a different wireless transmission standard. For example, a wireless transceiver circuit 108 may be compatible with the Wireless Local Area Network IEEE 802.11 standard known as WiFi. Transceiver circuit 108 may be configured to detect a WiFi access point in proximity to the test meter 10 and to transmit and receive data from such a detected WiFi access point. A wireless transceiver circuit 109 may be compatible with the Bluetooth protocol and is configured to detect and process data transmitted from a Bluetooth “beacon” in proximity to the test meter 10. A wireless transceiver circuit 110 may be compatible with the near field communication (“NFC”) standard and is configured to establish radio communication with, for example, an NFC compliant point of sale terminal at a retail merchant in proximity to the test meter 10. A wireless transceiver circuit 111 may comprise a circuit for cellular communication with cellular networks and is configured to detect and link to available cellular communication towers.

A power supply module 116 is electrically connected to all modules in the housing 11 and to the processing unit 122 to supply electric power thereto. The power supply module 116 may comprise standard or rechargeable batteries 118 or an AC power supply 117 may be activated when the test meter 10 is connected to a source of AC power. The power supply module 116 is also electrically connected to processing unit 122 over the communication interface 123 such that processing unit 122 can monitor a power level remaining in a battery power mode of the power supply module 116.

In addition to connecting external storage for use by the test meter 10, the data port 13 can be used to accept a suitable connector attached to a connecting lead, thereby allowing the test meter 10 to be wired to an external device such as a personal computer. The data port 13 can be any port that allows for transmission of data such as, example, a serial, USB, or a parallel port.

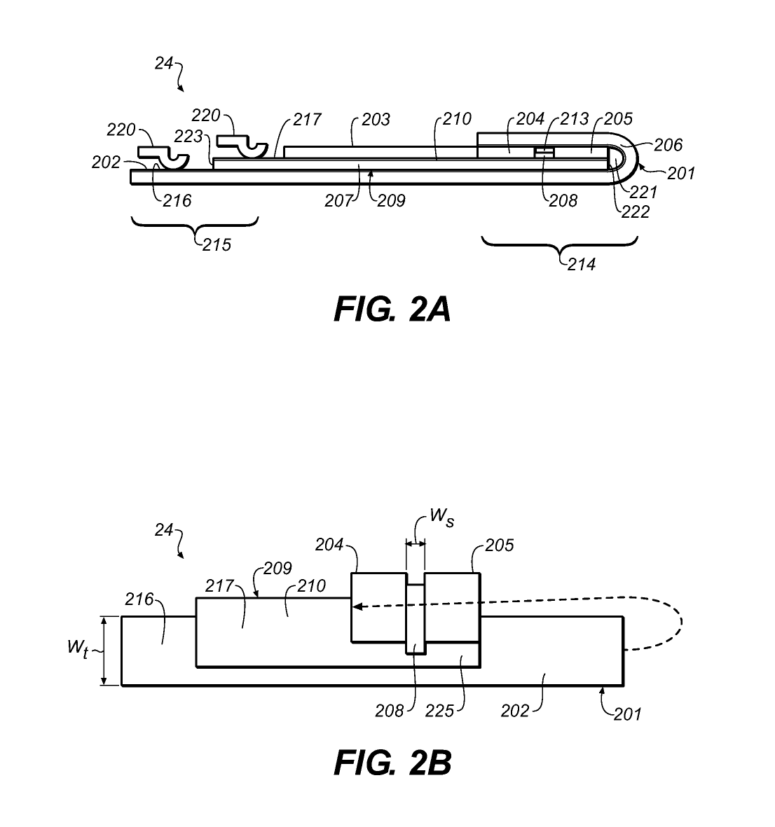

FIGS. 2A-2B illustrate an exemplary embodiment of an electrochemical biosensor 24, also referred to herein as a test strip, that is usable with the analyte meter 10. In brief and as shown, the test strip 24 generally includes a pair of electrodes, namely a top electrode 201 and a bottom electrode 209, a pair of spacers 204, 205, and a reagent layer 208, the latter layer being disposed between the spacers 204, 205 on the bottom electrode 209 according to this exemplary embodiment. A gap is formed between the spacers 204, 205 and as further defined by the top electrode 201 and the bottom electrode 209 forms a sample chamber 213, the latter which functions as an electrochemical cell. The sample chamber 213 extends across the width of the test strip Wₜ and provides inlets at opposing ends which may be used for applying a sample therein. A person skilled in the art will appreciate that the test strip 24 can have various configurations other than those shown, and can include any combination of features disclosed herein and known in the art. Moreover, each test strip 24 can include a sample chamber 213 at various locations for measuring the same and/or different analytes in a sample.

The test strip 24 can have various configurations, but it is typically in the form of rigid, semi-rigid, or flexible spacers 204, 205, and flexible web-based substrate layers 206, 207, each having a generally elongated, rectangular, planar shape, and sufficient structural integrity to allow handling and connection to an analyte measurement system or device, such as a test meter, as will be discussed in further detail below. Each of the various test strip layers 204, 205, 206 and 107 may be formed from suitable materials, including plastic, polyester, or other materials. More specifically, the material of these layers is electrically non-conductive and may be inert and/or electrochemically non-functional, where they do not readily corrode over time nor chemically react with a sample applied to the sample chamber 213 of the test strip 24. According to this embodiment, the top electrode 201 includes a flexible insulating layer 206 and a flexible conductive material, or conductive film layer, 202 disposed on one surface thereof. As shown in the orientation of FIG. 2A, the conductive film layer 202 faces upward at the proximal end 215 of the test strip 24 and faces downward at its distal end 214, i.e., it is folded over and faces the electrode 209 across the sample chamber 213. According to this exemplary embodiment, the bottom electrode 209 also includes a flexible insulating layer 207 and a flexible conductive material, or layer, 210 disposed on one surface thereof. At the distal end 214 of the test strip 24, the conductive layer 210 faces upward toward the electrode 209 across the sample chamber 213. The conductive layers 202, 210 should be resistant to corrosion wherein their conductivity does not change during storage of the test strip 24.

In the embodiment shown in FIGS. 2A-2B, the conductive layers 202, 210 of the test strip 24 further provide contact areas 216, 217 at a proximal end 215 of the electrodes 201, 209 for electrically communicating with electrical contacts 220, or prongs, disposed in the strip port connector 22 of the analyte meter 10. As illustrated in FIG. 2A a pair of electrical contacts 220, or prongs, of the test meter 10, may easily electrically engage the contact areas 216, 217 of the test strip 24. As shown, the top electrode 201 extends beyond a terminal edge 223 of the bottom electrode 209 such that an axial portion of its conductive surface 202 is exposed at the proximal end 215 of the test strip 24 to form one electrical contact 216 of the test strip 24. A protective layer 203 may be applied to a portion of the conductive layer 210 of the bottom electrode 209, proximate the spacer 204, leaving exposed a portion of the conductive layer 210 at the proximal end of the test strip 24, to form a second electrical contact 217 of the test strip 24. Because the conductive electrode layers 202, 210 are applied to the planar surfaces of the stacked electrode layers 201, 209, they are disposed in separate, but parallel, planes at different heights, and are further offset in a longitudinal direction, i.e., along a line between the opposing distal end 214 and proximal end 215 of the test strip 24. The electrical contacts 220, or prongs, of the analyte measurement device are, therefore, similarly configured to be offset in a vertical (height) direction and along the longitudinal direction to properly engage the electrical contacts 216, 217 of the test strip 24. Such a configuration facilitates engagement of the top and bottom electrodes 201, 209 by an analyte measurement device 100 and allows the device to measure an analyte concentration of a fluid sample provided in electrochemical sample chamber 213 by known means. As illustrated in FIG. 2A-2B and according to this exemplary embodiment, the electrical contacts 216, 217 are both upwardly facing for establishing electrical contact therewith without further modification.

The top and bottom electrodes 201, 209, respectively, each comprise a substantially insulating and inert substrate, 206, 207, respectively, and have the conductive film material disposed on one surface thereof 202, 210, respectively, to facilitate electrical communication between the electrodes 201, 209 and an analyte measurement system 100. The electrically conducting layers 202, 210 may be formed from any conductive material, including inexpensive materials, such as aluminum, carbon, graphene, graphite, silver ink, tin oxide, indium oxide, copper, nickel, chromium and alloys thereof, and combinations thereof (e.g., indium doped tin oxide) and may be deposited, adhered, or coated on the insulating layers 206, 207. Conductive precious metals, such as palladium, platinum, indium tin oxide or gold, may also be used. The conductive layers may be deposited onto the insulating layers 206, 207 by various processes, such as sputtering, electroless plating, thermal evaporation and screen printing. In one exemplary embodiment, the reagent-free electrode, e.g., the top electrode 201, is a sputtered gold electrode, and the electrode containing the reagent 208 thereon, e.g., the bottom electrode 209, is a sputtered palladium electrode. In use, one of the electrodes can function as a working electrode and the other electrode can function as the counter/reference electrode. The electrically conductive layers 202, 210 may be disposed on one entire surface of the electrodes 201, 209 or they may terminate at a distance (e.g., 1 mm) from the edges of the electrodes 201, 209. However, the particular locations of the electrically conductive layers 202, 210, should be configured to electrically couple the electrochemical cell of the sample chamber 213 to a corresponding analyte measurement device (e.g., test meter).

In one exemplary embodiment, the entire portion or a substantial portion of the surfaces of the top and bottom electrodes 201, 209 are coated with the electrically conducting layers 202, 210 at a preselected thickness. When the electrochemical test strip is assembled, as shown in FIG. 2A, the top electrode 201 is caused to be folded over the sample chamber 213, wherein the top electrode 201 is positioned such that at least a portion of its inverted conductive surface 202 and the conductive surface 210 of the bottom electrode 209 are in a facing relationship, i.e. “co-facial”, with one another. The folded structure of the top electrode 201 may form a secondary opening 221 adjacent a terminal edge 222 of the bottom electrode 209. If a fluid inadvertently enters the secondary opening 221, such as a sample bodily fluid applied to sample chamber 213, it may electrically short the conductive material 210 on the bottom electrode 209 to the conductive material 202 on the top electrode 201 proximate the secondary opening 221. Therefore and according to this embodiment, a gap 225 is formed in the conductive layer 210 between the sample chamber 213 and the terminal edge 222 of the bottom electrode. The gap 225 may be created by an ablation procedure, such as laser ablation, to remove a portion of the conductive layer 210 from the surface of the bottom electrode 209. Alternatively, other processes may be utilized. The ablated region disconnects the portion of the conductive layer 210 that may come into contact with a fluid in the secondary opening 221 from the conductive layer 210 that electrically contacts a reacted sample in the sample chamber 213.

According to the herein described embodiment and to maintain electrical separation between the top and bottom conductive layers 202, 210, the test strip 24 includes a spacer layer comprising a pair of spaced spacers 204, 205. These spacers 204, 205, may comprise double-sided adhesive spacers for securing the top and bottom electrodes 201, 209, in the spaced apart relationship as shown which form top and bottom walls of the sample chamber 213. As noted, the spacers 204, 205 themselves form side or lateral walls of the defined sample chamber 213. By separating the top and bottom electrodes 201, 209, the spacers 204, 205 prevent electrical contact between the co-facial top and base conducting layers 202, 210. The spacers 204, 205 may be formed from a variety of electrically non-conductive materials, including rigid, semi-rigid, or flexible material with adhesive properties, or the spacers 204, 205 may be attached to electrodes 201, 209 by a separate adhesive material applied thereon to attach the spacers 204, 205 to the inside surfaces of the top and bottom electrodes 201, 209. The spacer material may have a small coefficient of thermal expansion such that the spacers 204, 205 do not adversely affect the volume of the sample chamber 213 in use. According to the herein described embodiment, the spacers 204, 205 are defined by a width dimension that is substantially equal to a width dimension Wₜ (FIG. 2B) of the top and bottom electrodes 201, 209 and a length dimension that is significantly less than either of the top and bottom electrodes 201 or 209. The spacers 204, 205 may be configured in various shapes and sizes, for example the spacers may be generally planar, square or rectangular, and can be disposed in various locations between the top and bottom electrodes 201, 209. In the embodiment shown in FIGS. 2A-2B, the spacers 204, 205 are spatially separated by a distance Wₛ (FIG. 2B) to define side walls of the sample chamber 213. A person skilled in the art will appreciate that the location of the spacers, and the sample chamber defined thereby, can vary. Similarly, the test strip can also include electrical contact areas 216, 217 located anywhere along the conductive layers 202, 210, respectively, for coupling to an analyte measurement system 100 or device. Non-limiting examples of ways in which adhesives can be incorporated into the various test strip assemblies of the present disclosure can be found in U.S. Pat. No. 8,221,994 of Chatelier et al., entitled “Adhesive Compositions for Use in an Immunosensor”, the contents of which is incorporated by reference as if fully set forth herein in its entirety.

The top and bottom electrodes 201, 209 may be configured in any suitable configuration in an opposed spaced apart relationship for receiving a sample in the sample chamber 213. The illustrated reagent layer 208 may be disposed on either of the top or bottom electrodes 201, 209 between the spacers 204, 205 and within the chamber 213 for coming into physical contact, and reacting, with an analyte in a sample applied thereto. Alternatively, the reagent layer 208 can be disposed on multiple faces of the sample chamber 213. A person skilled in the art will appreciate that the electrochemical test strip 24, in particular the electrochemical cell formed thereby, may have a variety of configurations, including having other electrode configurations, such as co-planar electrodes. The reagent layer 208 can be formed from various materials, including various mediators and/or enzymes. Suitable mediators include, by way of non-limiting example, ferricyanide, ferrocene, ferrocene derivatives, osmium bipyridyl complexes, and quinone derivatives. Suitable enzymes include, by way of non-limiting example, glucose oxidase, glucose dehydrogenase (GDH) based onpyrroloquinoline quinone (PQQ) co-factor, GDH based on nicotinamide adenine dinucleotide co-factor, and FAD-based GDH. One exemplary reagent formulation, which would be suitable for making the reagent layer 208, is described in U.S. Pat. No. 7,291,256, entitled “Method of Manufacturing a Sterilized and Calibrated Test strip-Based Medical Device,” the entirety of which is hereby incorporated as if fully set forth herein by reference. The reagent layer 208 can be formed using various processes, such as slot coating, dispensing from the end of a tube, ink jetting, and screen printing. While not discussed in detail, a person skilled in the art will also appreciate that the various electrochemical modules disclosed herein can also contain a buffer, a wetting agent, and/or a stabilizer for the biochemical component.

As described above, the spacers 204, 205 and the top and bottom electrodes 201, 209 generally define a space or gap therebetween which forms the electrochemical cavity or sample chamber 213 for receiving a sample. In particular and as previously noted according to this embodiment, the top and bottom electrodes 201, 209 define the top and bottom of the sample chamber 213 and the spacers 204, 205 define the sides of the sample chamber 213. The gap between the spacers 204, 205 will result in an opening or inlet extending into the sample chamber 213 at both ends. The sample can thus be applied through either opening. In one exemplary embodiment, the volume of the sample chamber can range from about 0.1 microliters to about 5 microliters, preferably about 0.2 microliters to about 3 microliters, and more preferably about 0.2 microliters to about 0.4 microliter. To provide the small volume, the gap between the spacers 204, 205 have an area ranging from about 0.005 cm² to about 0.2 cm², preferably about 0.0075 cm² to about 0.15 cm², and more preferably about 0.01 cm² to about 0.08 cm², and the thickness of the spacers 204, 205 can range from about 1 micron to 500 microns, and more preferably about 10 microns to 400 microns, and more preferably about 40 microns to 24 microns, and even more preferably about 50 microns to 150 microns. As will be appreciated by those skilled in the art, the volume of the sample chamber 213, the area of the gap between the spacers 204, 205, and the distance between the electrodes 201, 209 can vary significantly.

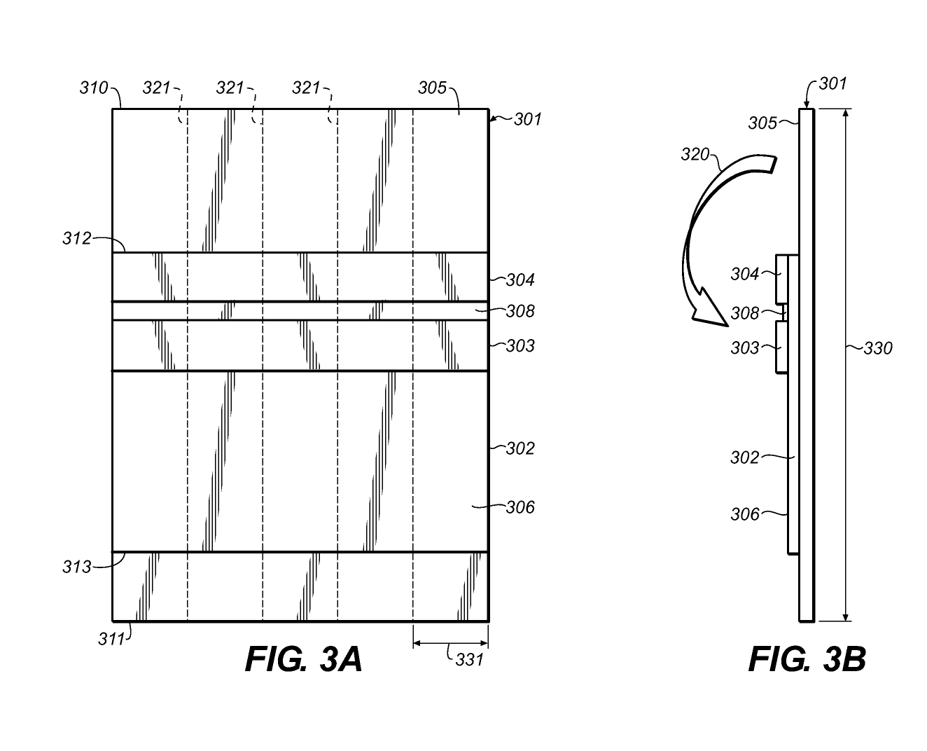

The test strip 24 can be fabricated using a continuous web process, as will now be described. With reference to FIGS. 3A-3B, the material used for fabricating the top and bottom electrodes 201, 209 as well as the spacers 204, 205, may be provided as a continuous web 301, 302, 303, and 304, respectively. The webs 301-304 may be prefabricated and supplied as rolled media or in substrate form. A polyester substrate having a conductive layer pre-applied thereon may be provided in rolled form to fabricate, or laminate, the top and bottom electrode layers 201, 209. For example, a first web of polyester 301 having two opposite parallel edges 310, 311, and having a gold layer applied, or sputtered, thereon may be unrolled from a spool, while simultaneously unrolling a second web of polyester 302 having two opposite parallel edges 312, 313, and having a palladium layer 306 applied, or sputtered, thereon. As shown in FIG. 3A, the web 301 is wider than the web 302, and the parallel edges 310, 311 of the first web 301 extend beyond the parallel edges 312, 313 of the second web 302.

An adhesive is disposed on a surface of the web 302 opposite the conductive layer 306 to adhere the second web 302 onto the first web 301. A straight strip of reagent 308 may be applied to the conductive layer 306, which reagent layer 308 may require a drying step after application, while the bottom electrode web 302 is being applied to the top electrode web 301, or the reagent strip may alternatively be pre-applied to the web 302 such that the web 302 is unrolled with the reagent layer 308 already applied thereon. Similarly, a laser ablation tool may be positioned adjacent the web 302 as it is unrolled to remove a portion 225 of the conductive material, as described above, or the conductive material 306 may be ablated prior to unrolling the web 302.

Similar to the fabrication procedure used to apply the bottom electrode web 302 against the top electrode web 301, double-sided adhesive spacers 303, 304, may be unrolled and applied in parallel to the web 302 such that the strip of the reagent layer 308 is disposed between the spacer layers 303, 304. The pair of spacers 303, 304 may be deposited, laminated, or adhered onto the conductive layer 302 and are separated by a gap having a width Wₛ which eventually forms the sample chamber 213 having the width Wₛ. The portion of the top electrode web 301 that extends beyond the top edge 312 of the bottom electrode web 302 is folded in the direction indicated by the arrow 320 over the spacers 303, 304 and adhered thereto. As a final step, the laminated web formed thus far is cut along the straight, parallel lines 321 to form a plurality of self-aligned, fully assembled singulated test strips 24, having easily engageable electrical contact areas 216, 217. Approximate dimensions of the materials used to fabricate the test strip 24 are as follows: the polyester web layers 301, 302 have thicknesses of about 175 μm; the spacers at about 50 μm up to about 175 μm; and the adhesive at about 25 μm. The test strip 24 dimensions comprise a length 330 of about 40 mm which reduces to a final length of about 30 mm after the folding step, and a width 331 of the test strip 24 after cutting may be about 3-4 mm.

It should be noted that the fabrication steps just described may be modified in various combinations as is well known to those skilled in the art. For example, the steps just described for forming the top and bottom electrodes 201, 209 may have a variety of configurations and sequences and are considered to be within the scope of the present disclosure. In another exemplary embodiment, the reagent layer 208 may be applied, as necessary, to the top electrode 201 instead of the bottom electrode 209. In yet another exemplary embodiment, instead of cutting the completed laminated layers formed by the fabrication process described above, the multi-layer laminate may be rolled onto a spool for storage, to be cut into individual test strips 24 at a later time. One advantage of the fabrication steps herein described is that the method does not require registration of the various material layers and makes use of an electrode web design that, when cut, forms the completed test strips 24 without wasting fabrication materials.

### PARTS LIST FOR FIGS. 1A-3B

10 test meter
11 housing, meter
13 data port
14 display
16 user interface buttons
22 strip port connector
24 test strip
100 analyte measurement system
101 memory module
102 input module
103 user interface module
104 strip port circuit module
105 microcontroller settings module
106 transceiver/wireless module
107 antenna
108 WiFi module
109 Bluetooth module
110 NFC module
111 GSM module
112 RAM module
113 ROM module
114 external storage
115 light source module
116 power supply module
117 AC power supply
118 battery power supply
119 display module
120 audio module
121 speaker
122 microcontroller (processing unit)
123 communication interface
125 test strip analyte module—analog front end
140 data management unit
201 top electrode
202 conductive layer, top electrode
203 protective layer
204 spacer
205 spacer
206 insulating substrate, top electrode
207 insulating substrate, bottom electrode
208 reagent layer
209 bottom electrode
210 conductive layer, bottom electrode
213 sample chamber
214 distal end
215 proximal end
216 electrical contact, electrode
217 electrical contact, electrode
220 prongs, test meter
221 terminal edge, bottom electrode
222 secondary opening
223 terminal edge, bottom electrode
225 ablated region
301 electrode web, top
302 electrode web, bottom
303 spacer
304 spacer
305 conductive layer, top electrode
306 conductive layer, bottom electrode
308 reagent layer
310 electrode web top edge
311 electrode web bottom edge
312 electrode web top edge
313 electrode web bottom edge
320 arrow
321 cutting lines
330 electrode web length
331 test strip width

While the invention has been described in terms of particular variations and illustrative figures, those of ordinary skill in the art will recognize that the invention is not limited to the variations or figures described. In addition, where methods and steps described above indicate certain events occurring in certain order, those of ordinary skill in the art will recognize that the ordering of certain steps may be modified and that such modifications are in accordance with the variations of the invention. Additionally, certain of the steps may be performed concurrently in a parallel process when possible, as well as performed sequentially as described above. Therefore, to the extent there are variations of the invention, which are within the spirit of the disclosure or equivalent to the inventions found in the claims, it is the intent that this patent, including the following claims, will further cover those variations as well.

What is claimed is:

1. An analytical test strip comprising:
a first substrate having a first conductive surface;
a second substrate having a second conductive surface facing the first conductive surface, and in which a first axial portion of the first substrate extends beyond a first terminal edge of the second substrate;
at least one spacer disposed between the first and second conductive surfaces for maintaining the first and second conductive surfaces in a spaced apart relationship, the first and second conductive surfaces defining top and bottom walls of a defined reaction chamber; and
wherein the first axial portion of the first substrate is folded over the first terminal edge of the second substrate and onto the at least one spacer, thereby forming the reaction chamber.

2. The test strip of claim 1, including a pair of spacers, each spacer defining a wall of the reaction chamber.

3. The test strip of claim 1, wherein the first conductive surface comprises a conductive coating made from gold.

4. The test strip of claim 3, wherein the second conductive surface comprises a conductive coating made from palladium.

5. The test strip of claim 1, further comprising a reagent layer on one of the first and second conductive surfaces forming the reaction chamber.

6. The test strip of claim 5, wherein the second conductive surface includes a gap disposed between the reaction chamber and the first terminal edge.

7. The test strip of claim 3, wherein the first and second substrates each comprise polyester.

8. The test strip of claim 3, wherein the first substrate comprises a transparent polyester.

9. The test strip of claim 1, wherein a second axial portion of the first substrate extends beyond a second terminal edge of the second substrate, the second terminal edge opposite the first terminal edge; and
wherein the first conductive surface comprises a first electrical contact of the biosensor and the second conductive surface comprises a second electrical contact of the biosensor.

10. An analytical test strip comprising:
a first electrode comprising a first conducting surface;
a second electrode comprising a second conducting surface, the first and second conducting surfaces facing each other across a defined reaction chamber, the second electrode attached to the first electrode, and the first electrode folded over at one end such that it extends over, and defines, the reaction chamber;
at least one spacer disposed between the first and second conducting surfaces adjacent the reaction chamber; and
wherein the first and second conducting surfaces further comprise electrical contacts of the biosensor configured for electrically engaging a test meter.

11. The test strip of claim 10, wherein the electrical contacts of the biosensor are disposed on separate parallel planes.

12. The test strip of claim 11, wherein the electrical contacts are axially offset from one another.

13. The test strip of claim 10, including a pair of spacers disposed between the first and second electrodes and having a spacing therebetween, in which the spacers form a first pair of walls of the defined reaction chamber.

14. The test strip of claim 13, wherein the first and second conducting surfaces of the first and second electrodes define a second pair of walls of the reaction chamber.

15. The test strip of claim 14, wherein at least one of the walls of the reaction chamber includes a reagent deposited thereon, and wherein the reaction chamber is configured to receive a fluid sample therein, to generate a reaction between the fluid sample and the reagent, and to complete an electrical circuit between the first and second conductive surfaces via the reacted fluid sample.

16. The test strip of claim 10, wherein the first electrode comprises a first polyester substrate carrying the first conducting surface and the second electrode comprises a second polyester substrate carrying the second conducting surface.

17. A method for determining an analyte concentration in a bodily fluid sample applied to an analytical test strip, the method comprising:
providing a test strip having a first substrate with a first conductive surface, a second substrate with a second conductive surface, having at least one spacer disposed thereon, facing the first conductive surface, and in which a first axial portion of the first substrate extends beyond a first terminal edge of the second substrate and is folded over the first terminal edge onto the at least one spacer to form a reaction chamber defined by at least the first and second conductive surfaces;
inserting the test strip into a test meter, the first and second conductive surfaces of said test strip forming electrical contacts of the test strip in operable electrical contact with the test meter;
applying a bodily fluid sample to the reaction chamber; and
sensing an electrochemical response of the test strip using the test meter.

18. The method of claim 17, wherein a second axial portion of the first substrate extends beyond a second terminal edge of the second substrate, the first conductive surface on the second axial portion comprising a first one of the electrical contacts, and the second conductive surface proximate the second terminal edge comprising a second one of the electrical contacts.

19. The method of claim 18, wherein the first and second electrical contacts are formed in different parallel planes.

20. The method of claim 19, wherein the first and second electrical contacts face the same direction.
